(19) United States
(12) Patent Application Publication
(10) Pub. No.: US 2005/0177754 A1
(43) Pub. Date: Aug. 11, 2005

(54) Password management peripheral system and method

(75) Inventor: Ali Pezeshk, Houghton, MI (US)

Correspondence Address: MICHAEL BEST & FRIEDRICH, LLP, 100 E WISCONSIN AVENUE, MILWAUKEE, WI, 53202, US

(73) Assignee: Board of Control of Michigan Technological University, Houghton, MI (US)

(21) Appl. No.: 10/774,878

(22) Filed: Feb. 9, 2004

(51) Int. Cl. H04L 9/00

(52) U.S. Cl. 713/202

(57) ABSTRACT

A password management system. The password management system includes a host computing processor that encrypts a list of passwords, and a portable access device. The portable access device stores the list of encrypted passwords, and communicates the list of encrypted passwords with the host computing processor through a peripheral port.

### BACKGROUND OF THE INVENTION

The present invention relates to computer system, and more particularly, to computer system access control.

Increase in usage of e-commerce or Internet raises questions regarding security of electronic accounts. Typically, access to each e-commerce or Internet account requires specific user identification and an associated password. Depending on levels of security desired, some accounts may even require more than one password for accessing different account information. Moreover, some accounts may require periodic change of user identification and password, with old user identification and passwords deemed obsolete and non-reusable, and thus new passwords have to be generated and ideally memorized. As a result, a typical user will have to handle a large number of user identifications and passwords. However, as the number of identifications and passwords increases, handling the number of user identifications and passwords becomes even more difficult.

The complexity of retrieving a password using brute force methods increases exponentially with the length of the password. On the other hand, longer passwords are generally more difficult to memorize, and thus less likely to be changed frequently. To ease the difficulty in memorizing a long password, users tend to choose longer passwords that are not a random combination of symbols. In such cases, non-random combination of symbols are generally more vulnerable to security threats. In many cases, users simply use the same user identification and password for all accounts, the same user identification and a set of correlated passwords for all accounts, or sometimes a set of shortest possible but correlated user identifications and passwords. In these cases, if one of the passwords is revealed, the security of other accounts is jeopardized as well. Use of weak passwords such as those related to personal information like birthdays and maiden name further increases the security threats. Furthermore, users may eventually forget either the user identification or the associated password, or both, associated with an account, if the account is accessed scarcely or after a long period of time.

### SUMMARY OF THE INVENTION

Accordingly, the present invention provides a password management system and method. The system can include a host computing processor that encrypts a list of passwords, and a portable access device to store a list of encrypted passwords and to communicate the list of encrypted passwords with the host computing processor through a peripheral port. The invention may also provide a password management system that includes a portable access device to store a list of encrypted passwords, an encryption module to encrypt a new password, and a driver to read a master access code.

The method of managing a list of passwords includes encrypting a list of passwords at a host computing processor, storing the list of encrypted passwords at a portable access device selectively coupled to the host computing processor, and communicating the list of encrypted passwords between the host computing processor and the portable access device.

Other features and advantages of the invention will become apparent to those skilled in the art upon review of the following detailed description, claims, and drawings.

### BRIEF DESCRIPTION OF THE DRAWINGS

FIG. 1 shows an embodiment of a password management system according to the present invention;

FIG. 2 shows an embodiment of a portable access device according to the present invention;

FIG. 3 shows a second embodiment of the portable access device according to the present invention;

FIG. 4 shows a third embodiment of the portable access device according to the present invention;

FIG. 5 shows a software driver system block diagram according to the present invention; and

FIG. 6 shows a memory bank arrangement of the portable access device according to the present invention.

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways. Also, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items. Unless limited otherwise, the terms “connected,” “coupled,” and “mounted” and variations thereof herein are used broadly and encompass direct and indirect connections, couplings, and mountings. In addition, the terms “connected” and “coupled” and variations thereof are not restricted to physical or mechanical connections or couplings.

### DETAILED DESCRIPTION

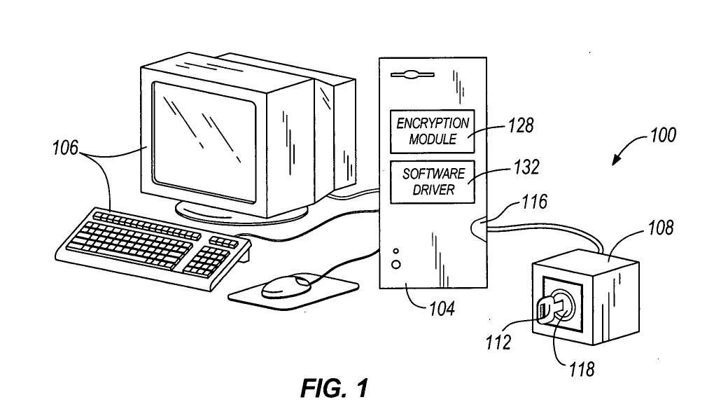

FIG. 1 illustrates a password management system 100 that includes a host computing processor 104, a user interface 106, a data flow or a read and write drive 108, and a portable access device (“PAD”) 112. Even though the host computing processor 104 is shown as a desktop computer in the embodiment, other computing processing units such as laptops, palmtops, personal digital assistants (“PDA”), a notebook, Power Mac, e-Mac, i-Mac, and the like can also be used. The host computing processor 104 generally has a peripheral port 116 that can be used to communicate with a peripheral device. Depending on the host computing processor 104, among other things, the peripheral port 116 can be a serial port such as a COM port or a universal serial bus (“USB”) port, a PS/2 connector, an internal expansion slot such as PCI slot or ISA slot, or the like.

The drive 108 is connected to the host computing processor 104 at the peripheral port 116. The drive 108 is thus an interface between the host computing processor 104 and the PAD 112. Furthermore, the drive 108 also has a PAD entry 118 into which the PAD 112 is inserted. The PAD entry 118 can be a key slot with internal contacts, a USB port, a PS/2, a magnetic swipe card, or the like. Although the drive 108 is shown as an external peripheral, the drive 108 can also be an internal interface device such as an internal expansion card or a riser card implemented inside the host computing processor 104 in some instances. If the drive 108 is an internal interface device, the internal drive 108 then has an option of having the PAD entry 118 on the internal interface device such that the PAD 112 can be coupled to the drive 108. The internal drive 108 can also be optionally configured to communicate with the peripheral port 116 of the host computing processor 104 and configure the existing peripheral port 116 on the host computing processor 104 as the PAD entry 118.

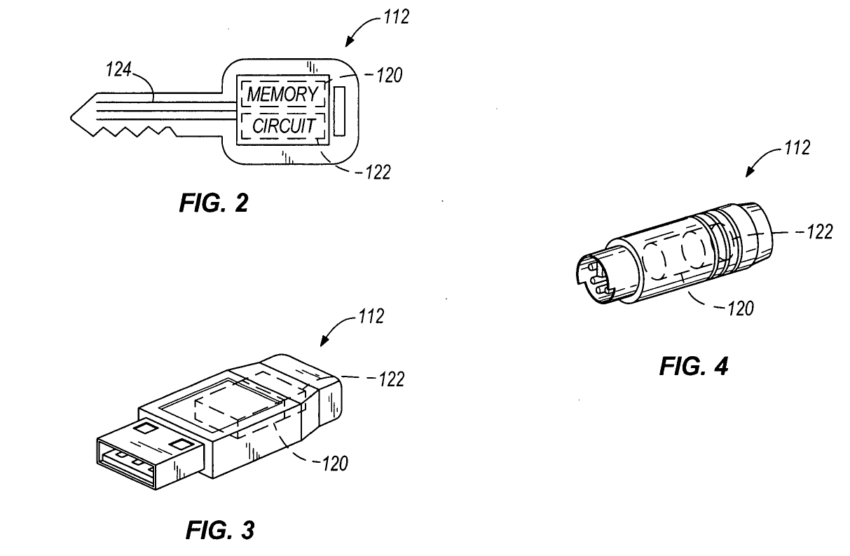

FIGS. 2, 3, and 4 show different embodiments of the PAD 112 according to the present invention. In general, the PAD 112 includes a rewritable or programmable memory 120 such as a serial EEPROM, optional protection and some internal circuitry 122 detailed hereinafter. Along with a list of passwords, other information associated with each password of the list can also be stored in the memory 120. For example, along with each password, user identifications, web site addresses, password expiration date, and the like will be stored in the memory 120. Further, a chassis with electromagnetic insulation such as a metallic insulation can be used to house and protect the memory 120 and the internal circuitry 122 from electromagnetic discharges and physical wears. The PAD 112 also includes a plurality of wiring or contacts 124 for electrical communication between the PAD 112 and the host computing processor 104 via the drive 108. The contacts 124 are generally engraved in the PAD 112 to reduce unwanted physical contact for durability. The PAD 112 will usually come at least in pairs, an active PAD and a back up PAD. Furthermore, the memory 120 can also optionally be protected with a protection circuit which can be part of the internal circuitry 122 against over-current and over-voltage surges to improve the reliability of the PAD 112. Although three PAD embodiments are shown, other types of PAD can also be used with the system 100.

Specifically, FIG. 2 shows a key-shaped PAD 112 with the contacts 124 exposed for engaging the drive 108. In the embodiments when the drive 108 is an internal device, other embodiments of the PAD 112 will be used. For example, FIG. 3 shows that the PAD 112 has a USB connector for connecting to a USB port controlled PAD entry 118 and monitored by the internal drive 108. FIG. 4 shows that the PAD 112 has a PS/2 connector for connecting to a PS/2 connecting port. In other embodiments, the PAD 112 can include the drive 108 as part of its internal circuitry 122. In such cases, the drive 108 generally includes a serial interface circuitry or chip as part of the internal circuitry 122 to interface between the PAD 112 and the host computing processor 104. In this way, a user will just need to carry a single PAD 112.

Referring again to FIG. 1, the system 100 also includes an encryption module 128. The encryption module 128 includes an encryption algorithm that can be implemented with either software or hardware. In the case of software implementation, the encryption module 128 will reside in a specific memory location of the host computing processor 104, which means that the PAD 112 can be used only on the designated host computing processor 104. Optionally, the software of the encryption module 128 can also reside in the memory 120 of the PAD 112. In this way, the PAD 112 can be used on non-designated host computing processors 104. Similarly, in the case of hardware implementation of the encryption module 128, the encryption module 128 can be part of the drive 108, or the host computing processor 104. A variety of encryption algorithms well studied and accepted by the Advanced Encryption Standard (“AES”), such as RC6, can be used with the encryption module 128. In the embodiment shown, the encryption algorithm is a symmetric or a single key algorithm with a minimum acceptable key length of 128. Furthermore, additional features such as variable key lengths and hashing functions such as MD5 can also be used if desired.

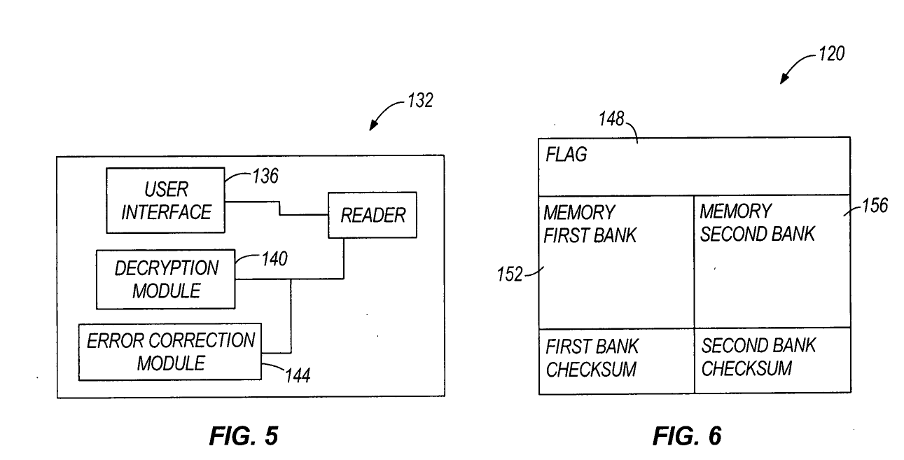

Similarly, the system 100 also includes a software driver 132 that resides on the host computing processor 104, as shown in FIG. 5. The software driver 132 further includes a user interface 136 to prompt and receive a master access password, and a decryption module 140 to decrypt password list stored in the PAD 112, detailed hereinafter. Furthermore, the software driver 132 can also have an error correction module 144 to perform error correction on data communicated to and from the PAD 112. Specifically, the memory 120 is generally very sensitive to electrical noise and ambient temperature, and the error correction module 144 will perform error correction coding and decoding on the data being written to and read from the PAD 112. A variety of coding schemes with high error detection and correction capabilities such as Reed-Muller codes can be used to ensure the integrity of the data stored. The software driver 132 can also set a flag register 148 of the memory 120 to indicate if a memory transfer is successful and complete.

FIG. 6 shows how the memory 120 is arranged on the PAD 112. In the embodiment shown, the memory is divided into two banks, a first bank 152, and a second bank 156. Specifically, to protect data stored in the memory 120 of the PAD 112 against any data transmission problems during updating of the data, the memory 120 is divided as shown.

Initially, data is stored in the active bank 152. Along with the data stored in the first bank 152, a checksum field is also stored. In the embodiment shown, the checksum field is determined using a hash function. Furthermore, the flag register 148 also keeps track of, specifies and indicates which of the two banks 152 or 156 is being used or active, and therefore the other bank is inactive. For example, if the active bank is configured to store the current password list, to prevent accidental loss of data, the software driver 132 will write the new encrypted list together with its checksum data to the inactive memory bank. The software driver 132 will then verify the write operation by reading the contents of the inactive memory bank. If the verification is successful, the flag register 148 in the PAD 112 is updated to point to the inactive bank as the new active memory bank. However, if there has been any data transmission error, the software driver 132 will not change the contents of the flag register 148 in the PAD 112, thus the current password list will not be damaged as a result of transmission error. Optionally, the inactive bank may also serve as a backup in case the contents of the active bank get corrupted. In particular, only a few passwords are normally changed at a time in the active bank. When it is determined that there is a transmission error, or the data has been corrupted, the software driver 132 can repair the corrupted data in the active bank by replacing the corrupted data with the original uncorrupted data stored in the inactive bank.

The software driver 132 will also detect if the attached PAD 112 is blank, for example, in the case of storing data in the back up PAD. If the memory 120 of the connected PAD 112 is determined blank, the software driver 132 will prompt for the original PAD 112. The data in the memory 120 of the original PAD 112 is copied to a memory location on the host computing processor 104 after the original PAD 112 has been connected. The software driver 132 will prompt for the back up PAD. The data stored in the memory location on the host computing processor 104 is then copied to the back up PAD. The data in the memory is then optionally deleted or destroyed for security purpose.

To operate the system 100, a user will simply need to memorize a single password. As a result, the user may choose a very strong password consisting of a long concatenation of random symbols, dictionary words, or the like to protect the encrypted list of passwords. In this way, the user will be able to use much longer and different individual passwords for different accounts since they are stored in the memory 120 of the PAD 112. Furthermore, the master access password can also be changed occassionally depending on needs.

Specifically, the user will insert the PAD 112 into the PAD entry 118 of the drive 108 connected to the host computing processor 104, or directly into the peripheral port 116 or the PAD entry 118 as described when the drive 108 is installed as an internal device as described. When the software driver 132 has detected a PAD presence, the software driver 132 will prompt the user for a master password via the user interface 106. The software driver 132 compares the entry provided by the user to the master password in the memory of the PAD 112. Upon authenticating the master password entered, the software driver 132 permits the drive 108 to read data such as a list of passwords and associated information stored in the memory 120. The software driver 132 decodes and error corrects the data with the error correction module 144. The error-corrected data is then decrypted with the decryption module 140, and is thus available for use by the user.

Whenever the user visits an account, the software driver 132 will let the user choose the proper identification information from the decrypted password list. Alternatively, the software driver 132 may compare the address of the account being accessed with the additional account information stored along with the passwords in the list and automatically extract the required identification information from the PAD 112. If the account address does not match any of the entries in the list, the account is considered as new and the user will be prompted for the new identification information. After the user has entered a new password, the entered password is again entered or spoofed on the account or web page. Meanwhile, the software driver 132 will insert the new password along with its associated information into the existing list, thus creating a modified list of password.

When the user has finished working with the account or web page, the software driver 132 will prompt for user confirmation, encrypt the existing or the modified list of passwords along with its associated information at the host computing processor 104 using the master key provided by the user. Again, while the encryption is performed on the host computing processor 104, the encryption algorithm can be optionally retrieved from the PAD 112 for portability, or from a memory location on the host computing processor 104 specified by the software driver 132. The encrypted list is then transmitted through the drive 108 to the PAD 112 for storage. Writing to the memory 120 for storage will follow instructions described earlier regarding the memory banks, 152 and 156.

Various features and advantages of the invention are set forth in the following claims.

1. A password management system comprising:
a host computing processor having a peripheral port, and operable to encrypt a list of passwords; and
a portable access device adapted to be coupled to the host computing processor, the portable access device storing the list of encrypted passwords, and communicating the list of encrypted passwords with the host computing processor through the peripheral port.

2. The system of claim 1, wherein the portable access device further comprises a rewritable memory configured to store the list of encrypted passwords and account data associating each password, and configured to overwrite the list of passwords with a modified list of passwords.

3. The system of claim 1, wherein the portable access device comprises a first rewritable memory bank configured to store the list of encrypted passwords and account data associating each password, and a second rewritable memory bank configured to duplicate information stored in the first memory bank.

4. The system of claim 1, wherein the peripheral port comprises a universal serial bus (“USB”) port.

5. The system of claim 4, wherein the portable access device comprises a serial interface circuitry configured to communicate with the host computing processor via the USB port.

6. The system of claim 1, further comprising a data flow drive coupling the portable access device to the peripheral port of the host computing processor, being operable to read from the portable access device, and being operable to write to the portable access device.

7. The system of claim 1, wherein the host computing processor comprises an encryption module configured to encrypt the list of passwords.

8. The system of claim 7, wherein the encryption module comprises a symmetric encryption program.

9. The system of claim 1, further comprising a driver configured to read a master access code and to decrypt the list of passwords with the master access code.

10. The system of claim 1, further comprising a driver configured to update the list of encrypted passwords.

11. The system of claim 1, further comprising a driver configured to perform error correction on the list of passwords.

12. A password management system operable to be coupled to a computer having access to at least one account, the at least one account having a password associated therewith, the password management system comprising:
a portable access device storing in a rewritable memory a list of encrypted passwords for the at least one account;
an encryption module executed on the computer and operable to encrypt a new password for addition to the list of passwords; and
a driver coupled to the encryption module and operable to read a master access code, the driver decrypting the list of encrypted passwords from the portable access device using the master access code and updating the list of encrypted passwords with the new encrypted password.

13. The system of claim 12, wherein the rewritable memory comprises a first rewritable memory bank configured to store the list of encrypted passwords and account data associating each password, and a second rewritable memory bank configured to duplicate information stored in the first memory bank.

14. The system of claim 12, wherein the portable access device couples to the computer via a peripheral port.

15. The system of claim 14, wherein the peripheral port comprises a universal serial bus (“USB”) port.

16. The system of claim 15, wherein the portable access device comprises a serial interface circuitry configured to communicate with the computer via the USB port.

17. The system of claim 12, further comprising a data flow drive coupling the portable access device to the computer, being operable to read from the portable access device, and being operable to write to the portable access device.

18. The system of claim 12, wherein the encryption module comprises a symmetric encryption program.

19. The system of claim 12, wherein the driver performs error correction on the list of passwords.

20. A method of managing a list of passwords, the method comprising:
encrypting a list of passwords at a host computing processor;
storing the list of encrypted passwords at a portable access device selectively coupled to the host computing processor; and
communicating the list of encrypted passwords between the host computing processor and the portable access device.

21. The method of claim 20, wherein the portable access device further comprises a rewritable memory configured to store the list of encrypted passwords, and account data associating each password.

22. The method of claim 20, further comprising:
storing the list of encrypted passwords at a first memory bank of the portable access device; and
copying the list of encrypted passwords from the first memory bank to a second memory bank of the portable access device.

23. The method of claim 20, wherein communicating the list of encrypted passwords between the host computing processor and the portable access device comprises communicating with a peripheral port of the host computer processor, wherein the peripheral port comprises a universal serial bus (“USB”) port.

24. The method of claim 23, further comprising interfacing between the host computing processor and the portable access device using a serial interface circuitry on the portable access device via the USB port.

25. The method of claim 20, further comprising:
controlling data flow between the portable access device and the host computing processor;
reading from the portable access device a list of encrypted passwords; and
writing to the portable access device a list of encrypted passwords.

26. The method of claim 20, wherein encrypting the list of passwords comprises using a symmetric encryption program.

27. The method of claim 20, further comprising:
reading a master access code; and
decrypting the list of passwords with the master access code.

28. The method of claim 20, further comprising updating the list of encrypted passwords.

29. The method of claim 20, further comprising performing error correction on the list of passwords.
